(19) United States
(12) Patent Application Publication
(10) Pub. No.: US 2015/0019985 A1
(43) Pub. Date: Jan. 15, 2015

(54) SYSTEMS AND METHODS FOR CUSTOMIZING A WEB BROWSER

(71) Applicants: Glen MURPHY, Palo Alto, CA (US); Sailesh Agrawal, Santa Clara, CA (US)

(72) Inventors: Glen MURPHY, Palo Alto, CA (US); Sailesh Agrawal, Santa Clara, CA (US)

(73) Assignee: GOOGLE INC., Mountain View, CA (US)

(21) Appl. No.: 13/225,136

(22) Filed: Sep. 2, 2011

(51) Int. Cl. G06F 3/01

(52) U.S. Cl. 715/744

(57) ABSTRACT

Systems and methods for customizing a web browser are provided. In some aspects, a system includes a selection module configured to determine a first profile of the web browser. The first profile is associated with a first user of the web browser and a first configuration of the web browser. The system also includes a retrieval module configured to obtain social networking information associated with the first user. The system also includes a synchronization module configured to update the first configuration of the web browser based on the social networking information.

### FIELD

The subject technology generally relates to web browsers and, in particular, relates to systems and methods for customizing web browsers.

### BACKGROUND

A web browser can be customized to meet the needs of a specific user. For example, bookmarks and extensions that are desired by the user can be added to the web browser. However, when the web browser is customized in this manner, it is generally not known who the web browser is customized for. This may be a problem, for example, if different users use the web browser. Furthermore, the customization of the web browser may not necessarily be up to date, and therefore may be insufficient for meeting the needs of the user.

### SUMMARY

According to various aspects of the subject technology, a system for customizing a web browser is provided. The system comprises a selection module configured to determine a first profile of the web browser. The first profile is associated with a first user of the web browser and a first configuration of the web browser. The system also comprises a retrieval module configured to obtain social networking information associated with the first user. The system also comprises a synchronization module configured to update the first configuration of the web browser based on the social networking information.

According to various aspects of the subject technology, a computer-implemented method for customizing a web browser is provided. The method comprises determining a first profile of the web browser. The first profile is associated with a first user of the web browser and a first configuration of the web browser. The method also comprises obtaining social networking information associated with the first user. The method also comprises updating the first configuration of the web browser based on the social networking information.

According to various aspects of the subject technology, a machine-readable medium encoded with executable instructions for customizing a web browser is provided. The instructions comprise code for determining a first profile of the web browser. The first profile is associated with a first user of the web browser and one or more settings of the web browser specific to the first user. The instructions also comprise code for obtaining social networking information associated with the first user. The instructions also comprise code for updating the one or more settings of the web browser based on the social networking information. The one or more settings comprises at least one of a toolbar display, a title bar display, and a new page display. The code for updating the one or more settings comprises code for automatically populating at least one of the toolbar display, the title bar display, and the new page display with the social networking information.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 illustrates an example of a system for customizing a web browser, in accordance with various aspects of the subject technology.

FIG. 2 illustrates an example of a method for customizing a web browser, in accordance with various aspects of the subject technology.

FIGS. 3, 4, and 5 illustrate an example of a web browser, in accordance with various aspects of the subject technology.

FIG. 6 is a block diagram illustrating components of a controller, in accordance with various aspects of the subject technology.

### DETAILED DESCRIPTION

In the following detailed description, numerous specific details are set forth to provide a full understanding of the subject technology. It will be apparent, however, to one ordinarily skilled in the art that the subject technology may be practiced without some of these specific details. In other instances, well-known structures and techniques have not been shown in detail so as not to obscure the subject technology.

A user may customize a web browser in various ways, such as by customizing bookmarks, extensions (e.g., add-ons to the web browser), and other web browser settings. However, if the user desires to maintain the same customization in different devices (e.g., different laptop computers, desktop computers, mobile phones, tablets, etc.), the user may need to repeat the customization for each of the different devices. To remedy this, a user profile of the web browser may be generated. The user profile may be associated with the user and a particular configuration of the web browser. This configuration may be synchronized among all the different devices. For example, when the user is using a web browser of a particular device, the user may sign into the web browser with the user profile. The configuration associated with the user profile may then be uploaded to a server. If the user signs into a web browser of a new device with the user profile, the configuration may be retrieved from the server (e.g., over a network) and the configuration can be applied to the web browser of the new device, thereby obviating the need for the user to personally customize the web browser running on the new device. However, when the web browser is customized in this manner, it is generally not known who the web browser is customized for, which can be a problem especially when multiple users use the new device.

According to certain aspects, the subject technology solves the foregoing problem by allowing a user to opt into using the user's social networking information to customize a web browser. The social networking information, for example, may comprise the user's social networking profile image as well as the user's social networking profile name. The social networking information may be used to automatically populate one or more areas of the web browser, thereby allowing the user (for which the current customization belongs to) to be identified. For example, the social networking information may be displayed prominently on the web browser, such as on the web browser's new tab page. The social networking information may also be used to automatically populate certain fields of web pages accessed using the web browser. Furthermore, the user may update the social networking information frequently, and thus, the social networking information may be more up to date in reflecting the user's intent than a current configuration of the web browser. In this regard, the social networking information may be used to update the configuration of the web browser.

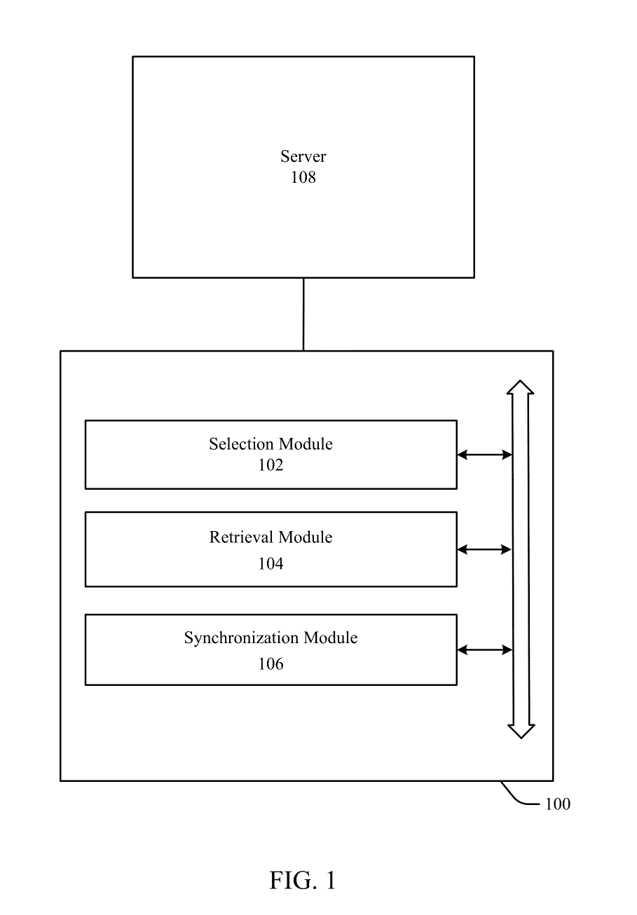

FIG. 1 illustrates an example of system 100 for customizing a web browser, in accordance with various aspects of the subject technology. System 100 may be part of a client device (e.g., a laptop computer, a desktop computer, a mobile phone, a tablet, etc.) that is running the web browser. System 100 may be in communication with server 108 (e.g., over a network), which may store the social networking information, the configuration of the web browser, and/or any other information for customizing the web browser. System 100 comprises selection module 102, retrieval module 104, and synchronization module 106. These modules may be in communication with one another. In some aspects, the modules may be implemented in software (e.g., subroutines and code). In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

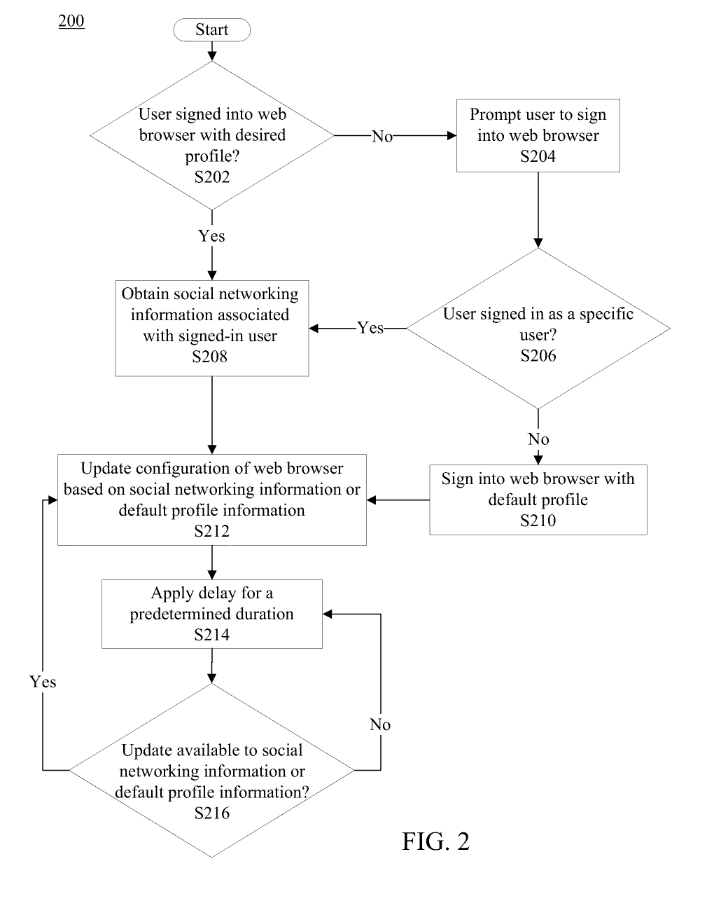

FIG. 2 illustrates an example of method 200 for customizing a web browser, in accordance with various aspects of the subject technology. The web browser may have multiple profiles, each of which is associated with a different user and a different corresponding configuration for the web browser. A default profile that is not associated with any particular user or does not use information from server 108 to update the web browser may also be used. For example, the default profile may be a guest profile.

In some aspects, each configuration may comprise one or more settings of the web browser specific to a corresponding user. The one or more settings may comprise at least one of a toolbar display, a title bar display, a new page display, auto-fill information for one or more fields of a web page, a bookmark, a web application, an extension, a theme, a home page preference, a startup preference, a password display preference, a phishing and malware detection preference, a domain name system (DNS) pre-fetching preference, an address bar suggestion preference, a navigation error suggestion preference, a download location preference, a web content preference, a clear-browser data preference, a translation preference, a language preference, a spell-checker preference, a page zoom preference, and other settings of the web browser that can be personalized for a user's needs.

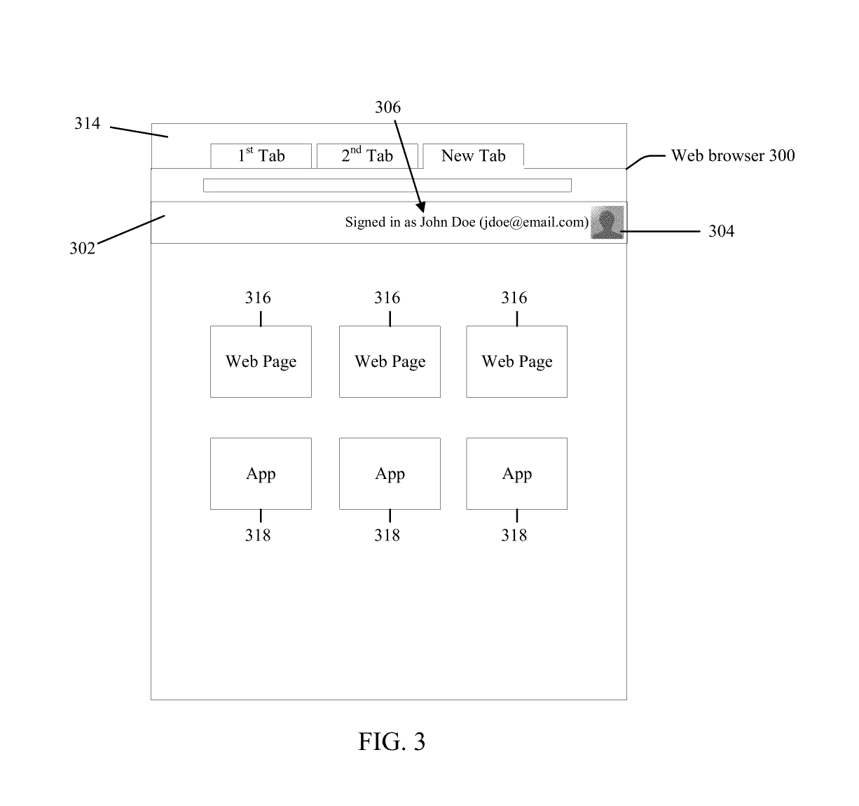

FIG. 3 illustrates an example of web browser 300, in accordance with various aspects of the subject technology. Web browser 300 may support multiple tabs, as illustrated by the 1st tab, 2nd tab, and the new tab page. In the new tab page, multiple bookmarks 316, application links 318, and other shortcuts may be displayed to allow the user access to those items. Web browser 300 comprises toolbar display 302 and title bar display 314. Although toolbar display 302 and title bar display 314 are shown on a top side of web browser 300, these displays can be formed on other sides, corners, or areas of web browser 300. According to certain aspects, web browser 300 may be configured to support synchronization of its configuration among a plurality of devices that can run web browser 300. For example, by having the user sign into web browser 300 with a particular profile on one device, the configuration of web browser 300 associated with that particular profile may be uploaded to a cloud server (e.g., server 108), and the configuration may be applied to web browser 300 running on another device once the user signs in again.

To determine which user web browser 300 should be customized for, selection module 102 may determine which profile is used to sign into web browser 300 with. According to step S202 in FIG. 2, selection module 102 may determine if a particular user is signed into web browser 300 with a desired profile (e.g., such as a profile that is associated with the particular user). If not, then according to step S204, selection module 102 may prompt the user to sign into web browser 300. The user may either sign in as a specific user or as a default user (e.g., a guest or some other person who does not desire to use information from server 108 to update web browser 300). According to step S210, the default user may sign into web browser 300 with the default profile. In some aspects, the default profile may be associated with default profile information concerning the default user that can also be used to customize web browser 300 with. For example, this default profile information may comprise a profile image of the default user, a profile name of the default user, and any other interests, preferences, or personal information that can be used to update the configuration of web browser 300.

If the user signs in with a profile that is specific to the user, then according to step S208, retrieval module 104 may obtain social networking information associated with the user. For example, retrieval module 104 may retrieve the social networking information from server 108, which may assist in providing a social networking service and store the social networking information. The social networking information may comprise at least one of a profile image of the user, a profile name of the user, and any other interests, preferences, or personal information that can be used to update the configuration of web browser 300. For example, if the user's social networking information indicates an interest in a certain web page, that information can be used to update the bookmarks of web browser 300.

Once the user has signed in with either the user-specific profile or the default profile, the configuration of web browser 300 can be updated. According to step S212, synchronization module 106 may update the configuration of web browser 300 based on the social networking information or the default profile information. If the user is signed in with the user-specific profile, then synchronization module 106 may update the configuration of web browser 300 based on the social networking information.

For example, one of the settings of web browser 300 includes the auto-fill information. Web browser 300 can use this information to automatically complete one or more fields of a web page. The auto-fill information may comprise at least one of credential data, credit card data, address data, contact data, log-in data, password data, and other information that may be requested by a particular web page. According to certain aspects, synchronization module 106 may update the configuration of web browser 300 by populating the auto-fill information with the social networking information. Thus, the user's social networking information may be used to complete the one or more fields of a web page. For example, the user's social profile name may be used to complete a name entry of a web page. Other social networking information may be used to complete other fields of a web page.

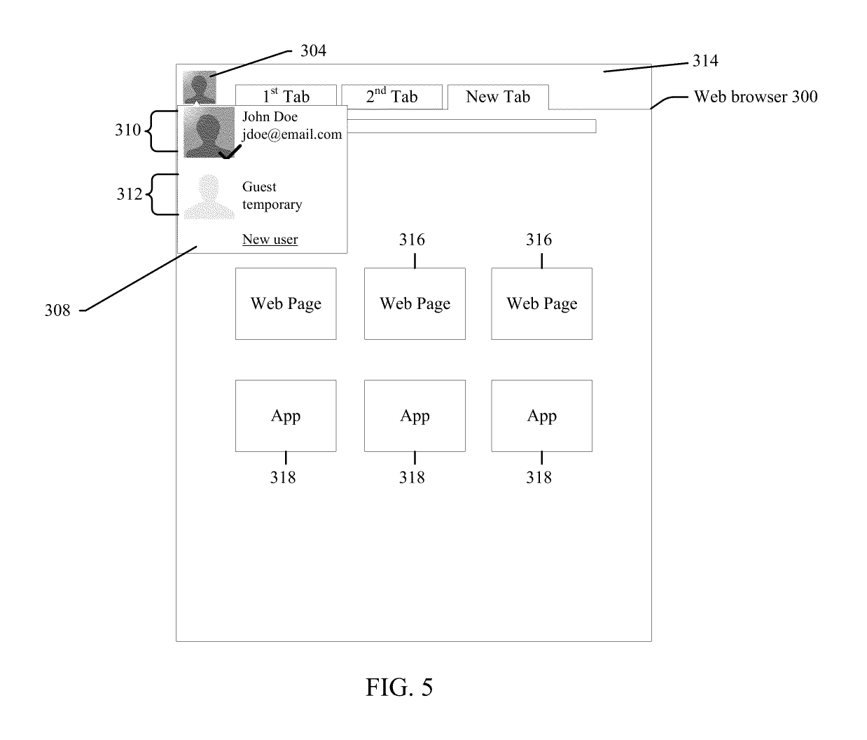

The configuration of web browser 300 may also be updated using the social networking information in other ways. For example, synchronization module 106 may automatically populate at least one of a toolbar display, a title bar display, and a new page display of web browser 300 with the social networking information. As shown, in FIG. 3, the social networking information is used to populate toolbar display 302 in the new tab page. For example, the user's social profile image 304 and the user's social profile name 306 are displayed in toolbar display 302. Thus, the current configuration of web browser 300 can be easily identified as that of the user signed in with the user-specific profile. The social networking information may also be displayed in other areas of web browser. For example, FIG. 5 illustrates that the social networking information can be displayed on toolbar display 314, in accordance with various aspects of the subject technology. As shown, the user's social profile image 304 is displayed on toolbar display 314, which conveniently identifies the user as the person that the current configuration of web browser 300 is customized for.

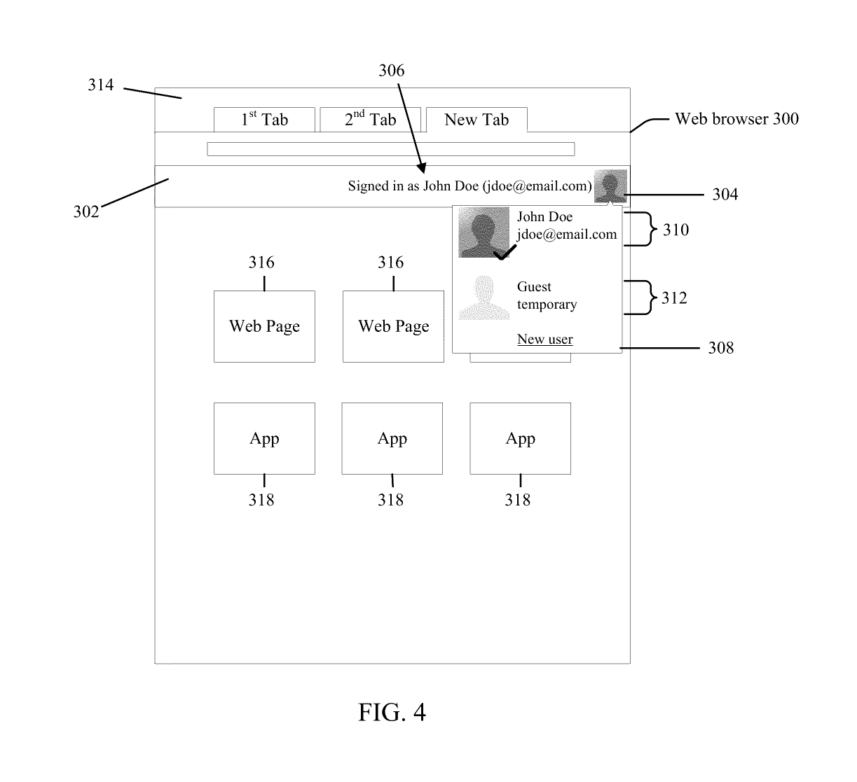

The subject technology may also provide a convenient way to change between different profiles of web browser 300. For example, as shown in FIGS. 4 and 5, if the user clicks on the user's social profile image 304, dropdown menu 308 may appear. Dropdown menu 308 may display the different profiles as different entries. For example, the user-specific profile is displayed in entry 310, as represented by the user's social profile image 304 and the user's social profile name 306 shown in this entry. A check mark next to the user's social profile image 304 in dropdown menu 308 may indicate that this corresponding profile is currently signed into web browser 300. However, the user may select a different profile such as by clicking on entry 312. The default profile (e.g., the guest profile) is displayed in entry 312. Thus, once the user clicks on entry 312, then the configuration associated with the default profile may be implemented on web browser 300, for example using the default profile information. According to certain aspects, the configuration of web browser 300 may be updated using the default profile information in a similar manner as using the social networking information. For example, the default profile information may be used to populate the auto-fill information. In another example, the default profile image and default profile name may be used to populate toolbar display 302 and title bar display 314.

In some aspects, different users may sign into web browser 300 with different user-specific profiles. Each of these profiles may be associated with a different configuration that can be updated in a similar manner as described above (e.g., with respect to FIGS. 2, 3, 4, and 5) using the corresponding social networking information of the different users. Thus, multiple users may use web browser 300 running on the same device. Each of these users can access a different configuration of web browser 300 by simply selecting a different profile to sign in with.

Returning to FIG. 2, according to step S214, a delay can be applied for a predetermined duration after the configuration of web browser 300 has been updated in step S212. This predetermined duration, for example, may be on the order of several seconds, minutes, or hours. However, other durations of time may be used depending on the user's preference. After this delay, according to step S216, retrieval module 104 may determine if any updates are available to the social networking information obtained in step S208 or the default profile information. If available, then the configuration of web browser 300 can be updated again using the updated information in step S212. Otherwise, another delay can be applied in step S214.

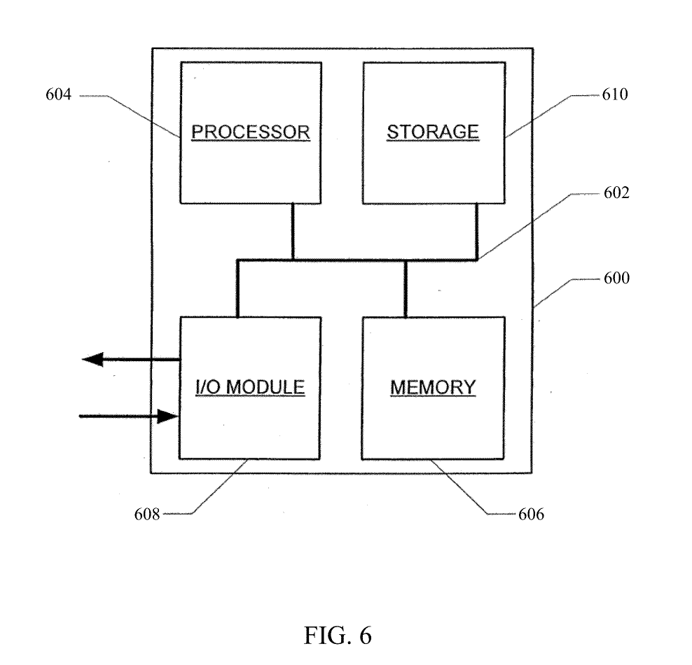

FIG. 6 is a block diagram illustrating components of controller 600, in accordance with various aspects of the subject technology. Controller 600 comprises processor module 604, storage module 610, input/output (I/O) module 608, memory module 606, and bus 602. Bus 602 may be any suitable communication mechanism for communicating information. Processor module 604, storage module 610, I/O module 608, and memory module 606 are coupled with bus 602 for communicating information between any of the modules of controller 600 and/or information between any module of controller 600 and a device external to controller 600. For example, information communicated between any of the modules of controller 600 may include instructions and/or data. In some aspects, bus 602 may be a universal serial bus. In some aspects, bus 302 may provide Ethernet connectivity.

In some aspects, processor module 604 may comprise one or more processors, where each processor may perform different functions or execute different instructions and/or processes. For example, one or more processors may execute instructions for customizing a web browser (e.g., method 200) and one or more processors may execute instructions for input/output functions.

Memory module 606 may be random access memory (“RAM”) or other dynamic storage devices for storing information and instructions to be executed by processor module 604. Memory module 606 may also be used for storing temporary variables or other intermediate information during execution of instructions by processor 604. In some aspects, memory module 606 may comprise battery-powered static RAM, which stores information without requiring power to maintain the stored information. Storage module 610 may be a magnetic disk or optical disk and may also store information and instructions. In some aspects, storage module 610 may comprise hard disk storage or electronic memory storage (e.g., flash memory). In some aspects, memory module 606 and storage module 610 are both a machine-readable medium.

Controller 600 is coupled via I/O module 608 to a user interface for providing information to and receiving information from an operator of system 100. For example, the user interface may be a cathode ray tube (“CRT”) or LCD monitor for displaying information to an operator. The user interface may also include, for example, a keyboard or a mouse coupled to controller 600 via I/O module 608 for communicating information and command selections to processor module 604.

According to various aspects of the subject disclosure, methods described herein are executed by controller 600. Specifically, processor module 604 executes one or more sequences of instructions contained in memory module 606 and/or storage module 610. In one example, instructions may be read into memory module 606 from another machine-readable medium, such as storage module 610. In another example, instructions may be read directly into memory module 606 from I/O module 608, for example from an operator of system 100 via the user interface. Execution of the sequences of instructions contained in memory module 606 and/or storage module 610 causes processor module 604 to perform methods to customize a web browser. For example, a computational algorithm for customizing web browser 300 may be stored in memory module 606 and/or storage module 610 as one or more sequences of instructions. Information such as the profiles, the social networking information, the default profile information, the configurations, and other suitable information may be communicated from processor module 604 to memory module 606 and/or storage module 610 via bus 602 for storage. In some aspects, the information may be communicated from processor module 604, memory module 606, and/or storage module 610 to I/O module 608 via bus 602. The information may then be communicated from I/O module 608 to an operator of system 100 via the user interface.

One or more processors in a multi-processing arrangement may also be employed to execute the sequences of instructions contained in memory module 606 and/or storage module 610. In some aspects, hard-wired circuitry may be used in place of or in combination with software instructions to implement various aspects of the subject disclosure. Thus, aspects of the subject disclosure are not limited to any specific combination of hardware circuitry and software.

The term “machine-readable medium,” or “computer-readable medium,” as used herein, refers to any medium that participates in providing instructions to processor module 604 for execution. Such a medium may take many forms, including, but not limited to, non-volatile media, and volatile media. Non-volatile media include, for example, optical or magnetic disks, such as storage module 610. Volatile media include dynamic memory, such as memory module 606. Common forms of machine-readable media or computer-readable media include, for example, floppy disk, a flexible disk, hard disk, magnetic tape, any other magnetic medium, a CD-ROM, DVD, any other optical medium, punch cards, paper tape, any other physical mediums with patterns of holes, a RAM, a PROM, an EPROM, a FLASH EPROM, any other memory chip or cartridge, or any other medium from which a processor can read.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

1. A system for customizing a web browser, the system comprising:
memory comprising instructions for customizing the web browser; and
a processor configured to execute the instructions,
wherein the instructions comprise:
a selection module configured to determine whether a first user is signed into the web browser with a first web browser profile, the first web browser profile being associated with first browser information for configuring one or more settings of the web browser;
a retrieval module configured to receive, in response to the determination that the first user is signed into the web browser with the first web browser profile, first social networking information associated with a first social networking profile of the first user for a social networking service; and
a synchronization module configured to update the one or more settings of the web browser based on the received first social networking information, wherein the one or more settings comprises auto-fill information for one or more fields of a web page, and the synchronization module is configured to update the auto-fill information with the first social networking information.

2. (canceled)

3. The system of claim 1, wherein the one or more settings comprises at least one of a toolbar display, a title bar display, a new page display, a bookmark, a web application, an extension, a theme, a home page preference, a startup preference, a password display preference, a phishing and malware detection preference, a domain name system (DNS) pre-fetching preference, a navigation error suggestion preference, a download location preference, a web content preference, a clear-browser data preference, a spell-checker preference, an address bar suggestion preference, a translation preference, a language preference, and a page zoom preference.

4. The system of claim 3, wherein the synchronization module is configured to automatically populate at least one of the toolbar display, the title bar display, and the new page display with the first social networking information.

5. The system of claim 1, wherein the auto-fill information comprises at least one of credential data, credit card data, address data, contact data, log-in data, and password data.

6. (canceled)

7. The system of claim 1, wherein the web browser is configured to support synchronization of the updated one or more settings among a plurality of devices configured to run the web browser.

8. The system of claim 1, wherein the first social networking information comprises at least one of a profile image of the first user and a profile name of the first user.

9. The system of claim 1, wherein the selection module is configured to determine whether a second user is signed into the web browser with a second web browser profile, the second web browser profile being associated with second browser information for configuring the one or more settings of the web browser.

10. The system of claim 9, wherein the retrieval module is configured to receive, in response to the determination that the second user is signed into the web browser with the second web browser profile, second social networking information associated with a second social networking profile of the second user for the social networking service, and wherein the synchronization module is configured to update the one or more settings of the web browser based on the second social networking information associated with the second user.

11. The system of claim 9, wherein the second browser information is specific to the second user.

12. A computer-implemented method for customizing a web browser, the method comprising:
determining whether a first user is signed into the web browser with a first web browser profile, the first web browser profile being associated with first browser information for configuring one or more settings of the web browser;
receiving, in response to the determination that the first user is signed into the web browser with the first web browser profile, first social networking information associated with a first social networking profile of the first user for a social networking service; and
updating the one or more settings of the web browser based on the received first social networking information, wherein the one or more settings comprises auto-fill information for one or more fields of a web page and updating the one or more settings of the web browser comprises updating the auto-fill information with the first social networking information.

13. (canceled)

14. The method of claim 12, wherein the one or more settings comprises at least one of a toolbar display, a title bar display, a new page display, a bookmark, a web application, an extension, a theme, a home page preference, a startup preference, a password display preference, a phishing and malware detection preference, a domain name system (DNS) pre-fetching preference, a navigation error suggestion preference, a download location preference, a web content preference, a clear-browser data preference, a spell-checker preference, an address bar suggestion preference, a translation preference, a language preference, and a page zoom preference.

15. The method of claim 14, wherein updating the one or more settings of the web browser based on the first social networking information comprises automatically populating at least one of the toolbar display, the title bar display, and the new page display with the first social networking information.

16. The method of claim 12, wherein the auto-fill information comprises at least one of credential data, credit card data, address data, contact data, log-in data, and password data.

17. (canceled)

18. The method of claim 12, wherein the web browser is configured to support synchronization of the one or more settings among a plurality of devices configured to run the web browser.

19. The method of claim 12, wherein the first social networking information comprises at least one of a profile image of the first user and a profile name of the first user.

20. (canceled)

21. The non-transitory machine-readable medium of claim 23, wherein the first social networking information comprises at least one of a profile image of the first user and a profile name of the first user.

22. The system of claim 1, wherein the first social networking information comprises at least one of an interest, a preference, and personal information of the first user.

23. A non-transitory machine-readable medium encoded with executable instructions for customizing a web browser, the instructions comprising code for:
determining whether a first user is signed into the web browser with a first web browser profile, the first web browser profile being associated with first browser information for configuring one or more settings of the web browser;
receiving, in response to the determination that the first user is signed into the web browser with the first web browser profile, first social networking information associated with a first social networking profile of the first user for a social networking service; and
updating the one or more settings of the web browser based on the received first social networking information, wherein the one or more settings of the web browser comprises auto-fill information for one or more fields of a web page, and updating the one or more settings of the web browser comprises updating the auto-fill information with the first social networking information.

24. The system of claim 1, wherein the first browser information is different from the first social networking information.

25. The system of claim 1, wherein the first social networking information is updated more frequently than the first browser information is updated.

26. (canceled)

27. The system of claim 1, wherein the synchronization module is configured to automatically populate a toolbar display of the web browser with a social profile image associated with the first user.

28. The system of claim 1, wherein the retrieval module is further configured to determine if an update to the first social networking information is available after a predetermined delay, and
wherein if the updated first social networking information is available, the synchronization module is further configured to update the one or more settings of the web browser based on the updated first social networking information.

29. The method of claim 12, further comprising automatically populating a toolbar display of the web browser with a social profile image associated with the first user.

30. The method of claim 12, further comprising:
determining if an update to the first social networking information is available after a predetermined delay, and
if the updated first social networking information is available, updating the one or more settings of the web browser based on the updated first social networking information.

31. The non-transitory machine-readable medium of claim 23, wherein the instructions further comprise code for automatically populating a toolbar display of the web browser with a social profile image associated with the first user.

32. The non-transitory machine-readable medium of claim 23, wherein the instructions further comprise code for:
determining if an update to the first social networking information is available after a predetermined delay, and
if the updated first social networking information is available, updating the one or more settings of the web browser based on the updated first social networking information.
